(19) United States
(12) Patent Application Publication
(10) Pub. No.: US 2026/0078807 A1
(43) Pub. Date: Mar. 19, 2026

(54) Adapter for Motor Pump Unit, Motor Pump Unit, and Operating Method

(71) Applicant: HMS-Hybrid Motion Solutions GmbH, Rutesheim (DE)

(72) Inventors: Achim HELBIG, Stuttgart (DE); Sven RICHTER, Weil der Stadt (DE)

(21) Appl. No.: 19/329,889

(22) Filed: Sep. 16, 2025

(30) Foreign Application Priority Data
Sep. 16, 2024 (DE) 102024126607.4

(51) Int. Cl. F16D 1/108; F16N 7/36

(52) U.S. Cl. CPC F16D 1/108; F16N 7/36; F16D 2300/06; F16D 2300/08

(57) ABSTRACT

An adapter for connecting an electric motor unit and a hydraulic pump unit, including: an adapter housing having a motor-side end face and a pump-side end face, wherein the motor-side end face and the pump-side end face each run perpendicular to an axis of rotation; a recess, running along the axis of rotation and provided in the adapter housing, for receiving a coupling unit, wherein a motor shaft of the motor unit and a pump shaft of the pump unit can be coupled to transmit torque; a seal receptacle provided in the recess in the region of the motor-side end face; a motor shaft seal, arranged on or in the seal receptacle, configured for arrangement on the motor shaft and for sealing the recess in the direction of the motor-side end face; and first and second fluid channels configured such that the recess fluidically connects the first fluid channel and the second fluid channel.

The invention relates to an adapter for a motor pump unit, to such a motor pump unit, and to a method for operating a motor pump unit.

Hydraulic systems use motor pump units that include a pump with a pipe threaded connection to transmit the hydraulic power, a motor, and a bell housing for mechanically connecting the housing of the motor and the pumps. Couplings are used to connect the motor and the pump and serve to transmit torque and speed, and thereby run dry.

Pumps with pipe thread connections have a high power density and are very compact. A plurality of pipes and hoses are required at the pump inlets and outlets, which require a lot of space in applications and machines. This design is particularly unsuitable for use in hydrostatic transmissions or hydraulic compact axles with self-contained hydraulics.

In such units, force-locking couplings are used, since positive-locking couplings are prone to fretting rust and high wear during dry operation. However, force-locking couplings are very large and long, require a large shaft diameter for power transmission, and have high inertia.

Dry operation is detrimental to the service life of the shaft seal. In addition, a shaft seal on the pump shaft is associated with considerable wear, since the pump shaft has a larger outer diameter and, due to being hydrodynamically/hydrostatically mounted, causes the pump shaft to move radially.

The bell housing used serves exclusively for the mechanical connection of the pump housing and the motor housing.

DE 10 2019 212 071 A1 discloses an adapter for connecting a motor unit and a pump unit, wherein no motor shaft seal is arranged on a motor-side end face of the adapter, and two pump-side fluid connections are not fluidically connected by means of a recess in the adapter running along an axis of rotation. Motor-pump devices are known from EP 3 504 433 B2, DE 10 2022 206 873 A1, DE 10 2021 205 558 A1, and EP 1 024 287 A1.

The object of the invention is that of providing an adapter for compact motor pump units, which enables a pump unit and a motor unit to be assembled in a modular fashion and improves longevity.

The object addressed by the invention is achieved by an adapter having the features of claim 1. The invention is directed at an adapter for connecting an electric motor unit, in particular one that is formed separately from the adapter, and a hydraulic pump unit, in particular one that is formed separately from the adapter, the adapter comprising: an adapter housing having a motor-side end face, in particular facing the motor unit, and a pump-side end face, in particular facing the pump unit, wherein the motor-side end face and the pump-side end face each run perpendicular to an axis of rotation; a recess, running along the axis of rotation and provided in the adapter housing, for receiving a coupling unit, wherein a motor shaft of the motor unit and a pump shaft of the pump unit can be coupled by means of the coupling unit for transmitting torque; a seal receptacle provided in the recess in the region of the motor-side end face; a motor shaft seal, preferably a radial shaft sealing ring, arranged on or in the seal receptacle, in particular a dynamic one, preferably a radial shaft seal, arranged on or in the seal receptacle, for arrangement on the motor shaft and for sealing the recess in the direction of the motor-side end face; a first fluid channel having a first fluid connection arranged in the pump-side end face; a second fluid channel having a second fluid connection arranged in the pump-side end face, wherein the first fluid channel and the second fluid channel are formed such that the recess fluidically connects the first fluid channel and the second fluid channel.

In the prior art, the pump operating fluid is sealed using a seal arranged on the pump shaft. Since the pump shaft is hydrodynamically/hydrostatically mounted, there is a high degree of play, which leads to high wear on the seal. The seal according to the invention for sealing the pump operating fluid present on the pump side, in particular oil, is provided by the motor shaft seal arranged in the adapter and, in the assembled state, arranged on the motor shaft. In contrast to the pump shaft, the motor shaft is ball-bearing mounted, which results in minimal play. This has the advantage that the motor shaft seal experiences significantly less wear and thus a significant increase in service life. Furthermore, IEC flange dimensions can thus be used, which is advantageous for the modularity of the motor pump unit.

By means of the first fluid connection, a pump operating fluid, in particular leakage oil and/or flushing oil, can be poured into the adapter and then flow into the recess via the first fluid channel. The coupling unit arranged there can be lubricated by means of the pump operating fluid. A wet coupling unit has less fretting rust and less wear. In addition, a wet coupling unit can be configured to be form-fitting and/or elastomer-free, whereby the coupling unit is small and compact and has low inertia. It is particularly advantageous that, in addition to the existing pump operating fluid, no additional oil is required. Furthermore, the pump operating fluid, after passing through the coupling unit, can be transported away by means of the second fluid channel and returned by means of the second fluid connection of the pump unit. This creates an additional flushing effect on the coupling unit, which transports dirt and particles accumulating in the recess away via the second fluid connection. Due to the pressure difference in the pump unit, in addition, no separate pump is required for flushing.

Conceptually, the adapter can preferably be divided into at least two regions by means of at least one plane running perpendicular to the axis of rotation, wherein a motor-side region is connected to the motor-side end face, and a pump-side region is connected to the pump-side end face. The motor-side region and/or the pump-side region extend along no more than 50%, in particular no more than 40%, preferably no more than 30%, preferably no more than 20%, of the adapter length, running parallel to the axis of rotation and between the two end faces. For the purposes of the invention, “in the region of the motor-side end face” is therefore to be understood as meaning that the element is arranged in the previously defined motor-side region and is arranged at least closer to the motor-side end face than to the pump-side end face.

An advantageous aspect of the invention provides that the first fluid channel have a first channel portion extending parallel to the axis of rotation and a second channel portion extending perpendicular to the axis of rotation, wherein the first channel portion opens, in particular directly, into the first fluid connection and/or the second channel portion opens, in particular directly, into the recess. Accordingly, the first fluid channel can be created by drilling. The first channel portion can preferably be introduced through the pump-side end face and the second channel portion through a lateral surface of the adapter. At the lateral surface, the second channel portion can be closed using a stopper.

An advantageous aspect of the invention provides that the second fluid channel have a first channel portion extending parallel to the axis of rotation and a second channel portion extending perpendicular to the axis of rotation, wherein the first channel portion opens, in particular directly, into the second fluid connection and/or the second channel portion opens, in particular directly, into the recess. Accordingly, the first fluid channel can be created by drilling. The first channel portion can preferably be introduced through the pump-side end face and the second channel portion through a lateral surface of the adapter. At the lateral surface, the second channel portion can be closed using a stopper.

Preferably, the second channel portion of the first fluid channel and the second channel portion of the second fluid channel are arranged coaxially with one another. Preferably, the second channel portion of the first fluid channel and sensor channel are arranged coaxially with one another.

An advantageous aspect of the invention provides that the first fluid channel, in particular its second canal portion, and/or the second fluid channel, in particular its second channel portion, be configured such that a fluid flowing between the first fluid channel and the second fluid channel flushes the motor shaft seal. It is advantageous if the second channel portion of the first fluid channel opens into the recess in the region of the motor-side end face and/or at the motor shaft seal. This ensures that sufficient pump operating fluid also flows past the motor shaft seal. This allows the motor shaft seal to be oiled or cooled on the one hand and dirt and particles to be removed on the other. This results in a significant increase in the service life of the motor shaft seal and thus also of the motor pump unit. This advantage also does not require any additional oil or an additional pump, since the fluid connections on the adapter allow the pump operating fluid of the pump unit to be conducted through the adapter.

The first fluid channel preferably opens into the adapter at a first recess opening. The recess opening preferably has an opening distance with respect to the motor shaft seal extending parallel to the axis of rotation of less than 300 mm, in particular less than 100 mm, preferably less than 50 mm, preferably less than 20 mm.

An advantageous aspect of the invention provides that the recess be arranged, in particular perpendicular to the axis of rotation, between the first fluid channel and the second fluid channel. Accordingly, the pump operating fluid can be easily conducted into the recess by means of the first fluid channel and conducted out of the recess by means of the second fluid channel.

An advantageous aspect of the invention provides that the motor shaft seal be configured for a pressure of more than 3 bar, in particular more than 5 bar, preferably more than 7 bar, and preferably equal to or more than 10 bar. The pump operating fluid, in particular the oil, is pressurized in order to flush the coupling unit and/or the motor shaft seal. It is therefore particularly advantageous for the seal to withstand a minimum load. If the pump operating fluid contains aggressive components, it is advantageous for the motor shaft seal to have high chemical resistance.

A sealing limit of the motor shaft seal preferably ranges from 25 bar*m/s to 40 bar*m/s. The sealing limit is closely linked to the seal service life. A form-fitting connection of the motor (toothing of the motor) must transmit at most the torque of the motor. In addition, the outer diameter of the motor shaft, in the region of the motor shaft seal, must be greater than or equal to the toothing to ensure assembly. The motor shaft can be configured in such a way that, in the region of the motor shaft seal, it is only as large as is necessary for assembly. This allows the circumferential speed at the sealing contact between the motor shaft seal and the motor shaft to be reduced, which has a positive effect on the service life of the motor shaft seal.

An advantageous aspect of the invention provides that the adapter further comprise a coupling unit arranged in the recess, in particular a form-fitting and/or elastomer-free coupling unit. Such coupling units are small and compact and have low inertia. The coupling unit enables the reliable and long-lasting transmission of power from the motor shaft to the pump shaft. The coupling unit preferably has an axial degree of freedom or axial play for the motor shaft and the pump shaft. Accordingly, temperature-related elongation of the waves can be compensated for.

An advantageous aspect of the invention provides that the adapter housing have at least one lateral surface that runs parallel to the axis of rotation and connects the end faces, wherein a sensor channel is provided, in particular extending perpendicular to the axis of rotation, which opens at one end into the at least one lateral surface and, at the other end, into the recess, and wherein a pressure sensor and/or a temperature sensor is/are arrangeable or arranged in the sensor channel. The sensor channel preferably has a thread for receiving a sensor.

Accordingly, an actual pressure and/or an actual temperature of the pump operating fluid in the adapter can be recorded. Depending upon the recorded data, conclusions can be drawn about the condition of the pump unit and/or the condition of the adapter, in particular the coupling unit and/or the motor shaft seal. Such monitoring can be carried out with an integrated or external control system. If an actual value exceeds a predetermined or established target value, the motor pump unit can be stopped.

An advantageous aspect of the invention provides that at least one relief hole, in particular running perpendicular to the axis of rotation and/or parallel to a lateral surface, be provided between the motor shaft seal and the motor-side end face for discharging pump operating fluid passing through the motor shaft seal. The relief hole can be used to ensure that pump operating fluid passing through the motor shaft seal can flow away. This ensures that this pump operating fluid does not pass (any further) into the motor unit.

It is generally not possible to ensure absolute tightness of a motor shaft seal over its entire service life. The motor shaft seal essentially goes through three phases over its service life: a running-in phase, sealing phase, and leakage phase. During the running-in phase, the motor shaft seal is not tight because tolerances mean there is no continuous line contact between the motor shaft seal and the motor shaft. After the motor shaft seal has been broken in, at least substantially continuous line contact is provided, and therefore the motor shaft seal is tight during the sealing phase. As wear increases, the motor shaft seal, especially the sealing ring, becomes rounded, resulting in no continuous lubricating film being present on the sealing edge. In addition, microcracks occur. Thus, a leak develops again during the leakage phase. During the leakage phase, the motor shaft seal should therefore be replaced.

An advantageous aspect of the invention provides that a fluid reservoir be provided between the motor shaft seal and the motor-side end face for receiving pump operating fluid passing through the motor shaft seal. Accordingly, the pump operating fluid can be received inside the motor pump unit, in particular between the adapter and the motor unit. During the running-in phase, there is still a leak between the motor shaft seal and the motor shaft, but little or no pump operating fluid reaches the lateral surface of the motor pump unit. Therefore, tight sealing when starting operation cannot be guaranteed, despite the running-in phase.

Without such a fluid reservoir, the fluid would leak out, which leads to criticism from customers, especially after the motor pump unit has been put into operation. Unavoidable leaking during the running-in phase can thus be encapsulated inside the motor pump unit.

The fluid reservoir is configured in such a way that the pump operating fluid passing through can be received during the running-in phase. However, the amount of pump operating fluid passing through during the leakage phase exceeds the capacity of the fluid reservoir. During the leakage phase, the quantity is significantly higher than during the running-in phase, and the fluid reservoir is then completely full. Afterwards, the pump operating fluid can be discharged by means of at least one relief hole. The escape of the pump operating fluid is therefore a reliable indicator that the motor shaft seal is sealed or is in the leakage phase. Due to the fluid reservoir, any misjudgment regarding the tightness of the motor shaft seal during the running-in phase is largely prevented.

To seal the fluid reservoir, it is preferable to provide another seal seat on the motor-side end face for sealing the fluid reservoir. Preferably, a reservoir seal is or can be arranged on the seal seat. The reservoir seal is preferably configured as a static seal. This ensures that pump operating fluid passing through can be purposely discharged at least substantially via the relief hole.

An advantageous aspect of the invention provides that the at least one relief hole open into the fluid reservoir by means of a relief connection, and wherein the relief connection is arranged on the fluid reservoir in such a way that an imaginary line connecting the relief connection and the axis of rotation forms an angle α ranging from 30°to 60°, in particular of 45°, with the at least one lateral surface. Accordingly, the motor pump unit can be assembled in different positions, in particular 0°, 90°, 180°, and/or 270°, and the advantages resulting from the fluid reservoir and the at least one relief hole continue to apply. Preferably, two opposite relief holes are arranged, each with a relief connection at 45°.

An advantageous aspect of the invention provides that a seal seat be provided on the pump-side end face, and wherein an adapter seal is or can be arranged on the sealing seat, which seals the recess and/or the first fluid channel and/or the second fluid channel toward the radial outside with respect to the axis of rotation. The adapter seal is preferably configured as a static seal. This ensures that the pump operating fluid can be safely conveyed between the pump unit and the adapter.

An advantageous aspect of the invention provides that fastening receptacles be provided on the motor-side end face for receiving motor-side fastening means, wherein the motor-side fastening means are configured for fastening the motor unit to the adapter. An advantageous aspect of the invention alternatively provides that fastening receptacles for receiving pump-side fastening means be provided on the pump-side end face, wherein the pump-side fastening means are configured to fasten the pump unit to the adapter. The fastening receptacles are preferably configured such that different motor units and/or pump units can be arranged on the adapter.

An advantageous aspect of the invention provides that a free end of a motor shaft of the motor unit and a free end of a pump shaft of the pump unit be arranged in the recess and be coupled by means of the coupling unit.

A bottom flange for arranging or fixing the adapter and/or the motor pump unit in a machine housing or frame is preferably arranged on a lateral surface of the adapter.

The fluid reservoir and/or the recess are preferably rotationally symmetrical.

The coupling unit is preferably arranged between the motor shaft seal and the pump unit. The fluid reservoir is preferably arranged between the motor shaft seal and the motor unit. The motor shaft seal is preferably arranged between the coupling unit and the fluid reservoir.

The object addressed by the invention is also achieved by a motor pump unit having the features of claim 14. The invention is directed at a motor pump unit having a motor unit, a pump unit, and an adapter, which connects the motor unit and the pump unit, according to one of the preceding claims. The adapter is preferably arranged between the motor unit and the pump unit. The lateral surface of the adapter is preferably at least substantially flush with the lateral surface of the motor unit and/or the pump unit.

The motor pump unit may further have a control block, in particular a hydraulic one, for connection to a hydraulic cylinder. The adapter and/or the pump unit are preferably arranged along the axis of rotation between the motor unit and the control block.

An advantageous aspect of the invention provides that the motor unit have a motor shaft extending along the axis of rotation into the recess, and wherein the motor shaft seal of the adapter is arranged on the motor shaft in such a way that pump operating fluid coming from the pump unit, in particular during the sealing phase, does not reach the motor unit.

Accordingly, pump operating fluid can flow through the adapter without affecting the motor unit. Flushing with the pump operating fluid means that contaminants and particles that impair service life can be removed.

An advantageous aspect of the invention provides that the pump unit have a pump shaft extending along the axis of rotation into the recess, and in particular wherein the pump shaft and the motor shaft are coupled in the recess by means of a coupling unit, in particular a positive-locking and/or elastomer-free coupling unit. Such a coupling unit is particularly small and compact. In addition, flushing with the pump operating fluid enables a long service life.

The pump unit is preferably configured for up to 200 bar, in particular up to 250 bar, preferably up to 300 bar, preferably up to 350 bar. This enables four-quadrant operation for hydrostatic transmissions and/or hydraulic compact axles. For four-quadrant operation, the pump unit is preferably configured such that the pump unit can realize a maximum positive and negative volume flow. In addition, the pump unit can be configured in such a way that the pump unit can provide a maximum positive and negative pressure difference. Accordingly, the pump unit is particularly suitable for applications that require a bidirectional volume flow and flexible pressure conditions.

An advantageous aspect of the invention provides that a fluid outlet corresponding to the first fluid connection and a fluid inlet corresponding to the second fluid connection be provided on a pump end face that faces the adapter such that a pump operating fluid can be conveyed from the pump unit to the adapter by means of the fluid outlet and the first fluid connection, and from the adapter back to the pump unit by means of the second fluid connection and the fluid inlet. The fluid outlet and the fluid inlet can be fluidically connected to a leakage line and/or flushing line, as is known from EP 4045800 B1. Accordingly, flushing oil and/or leakage oil from the pump unit can flow through the adapter, in particular the recess.

Preferably, the fluid inlet is connected to a flushing line of the pump unit. Preferably, the fluid outlet is connected to a leakage line of the pump unit. Preferably, the flushing line and/or the leakage line is/are formed separately from an intake line of the pump unit and/or a pressure line of the pump unit. Preferably, the pump unit has a first displacement chamber and a second displacement chamber, wherein the suction line opens directly into the first displacement chamber, and the pressure line opens directly into the second displacement chamber. Preferably, the flushing line and/or the leakage line is/are connected to the first displacement chamber and/or the second displacement chamber by means of gaps in a pump housing of the pump unit. An advantageous aspect of the invention provides that an adapter seal be provided between the adapter and the pump unit for sealing the connection between the fluid connections of the adapter and the fluid inlet and the fluid outlet of the pump unit. This ensures that the pump operating fluid is safely conveyed between the pump unit and the adapter.

A pump compact interface is preferably provided on a further pump end face, facing away from the adapter, of the pump unit, and enables a direct connection to a hydraulic control block.

An advantageous aspect of the invention provides that, in the motor unit, a further motor shaft seal, in particular a radial shaft sealing ring, be provided on the motor shaft for sealing a motor of the motor unit with respect to the fluid reservoir. Accordingly, it is additionally ensured that the pump operating fluid passing through the motor shaft seal of the adapter does not reach the motor and is preferably discharged through at least one relief hole to the lateral surface of the motor pump unit.

An advantageous aspect of the invention provides that the fluid reservoir be delimited at one end by the motor-side end face and at the other end by the motor unit, in particular the further motor shaft seal. Accordingly, the adapter and the motor unit have recessed portions that face one another and form the fluid reservoir when assembled. The fluid reservoir or the recessed portions form a cavity and/or spatial distance between the adapter and the motor unit parallel to the axis of rotation. This reduces heat conduction between the motor unit, especially the A-flange of the motor unit, and the adapter. This results in less heat generated by the motor unit being transferred to the adapter and the pump unit. Preferably, a further seal seat is arranged on the motor-side end face for sealing the fluid reservoir. The reservoir seal is preferably configured to be static. In addition, the pump operating fluid received in the fluid reservoir creates a cooling effect. The A-flange of the motor unit has a temperature ranging between 90° and 130° during operation. This leads to evaporation of the pump operating fluid in the fluid reservoir. The required evaporation enthalpy causes the motor unit, the adapter, and thus also the pump unit to cool down. If the pressure in the fluid reservoir increases, gases can escape through the relief hole and thus reduce the excess pressure. The running-in phase of the motor shaft seal ensures that pump operating fluid is present in the fluid reservoir at least at the start of operation.

The motor shaft seal and the adapter delimit a fluid chamber of the pump unit. The adapter, in particular its recess, and the pump unit are preferably fluidically connected.

The object addressed by the invention is also achieved by a method having the features of claim 21. The invention is directed at a method for operating a motor pump unit having a pump unit, a motor unit, and an adapter according to one of claims 1 to 13, wherein the adapter is formed separately from the pump unit and the motor unit, the method comprising the steps of: conducting the pump operating fluid from the pump unit into the adapter, and flushing the motor shaft seal and/or a coupling unit, which couples a motor shaft of the motor unit and a pump shaft of the pump unit, by means of the pump operating fluid. Accordingly, a motor pump unit with, among other things, a long service life is provided.

For the purposes of the invention, flushing is understood to mean the targeted and continuous passage of the pump operating fluid along a defined flow path, in which the fluid is conveyed and actively brought into contact with the motor shaft seal and/or the coupling unit and is then discharged from the corresponding region again. Random or diffuse flushing therefore does not occur; instead, it is a conscious measure for fulfilling several technical functions. The pump operating fluid is passed from the pump unit into the adapter along a defined path and conveyed along the sealing contours and/or the coupling components in the direction of flow. In a contact phase, the fluid achieves lubricating, cooling, and cleaning effects. The fluid can then be drained from the flushing region to allow the removal of heat, particles, and potential deposits.

Such a flushing process not only serves for passive moistening, but also actively fulfills functional tasks: It reduces the thermal load on the seal through convective heat dissipation, extends the service life by preventing deposits and frictional wear, and, if necessary, also supports the build-up of pressure in hydrostatic or hydrodynamic sealing systems. What is crucial is that the flushing chamber is not a dead space, but forms a fluidically continuous channel with a defined entrance and exit for the medium. It is advantageous if the method further comprises the step of returning the pump operating fluid, conducted past the motor shaft seal and/or coupling unit, to the pump unit.

Preferably, the pump operating fluid is introduced into the adapter at a first fluid connection and conveyed into a recess by means of a first fluid channel. The motor shaft seal and/or the coupling unit are preferably arranged in the recess. Preferably, the pump operating fluid is then discharged from the adapter via a second fluid channel out of a second fluid connection.

Further advantages, features, and details emerge from the following description, in which various exemplary embodiments of the invention are illustrated with reference to the drawings. The features mentioned in the claims and in the description may in each case be essential to the invention individually or in any desired combination.

To enable a better understanding of the present invention, and to show how the same may be carried into effect, certain embodiments of the invention are explained in more detail with reference to the drawings, by way of example only, in which:

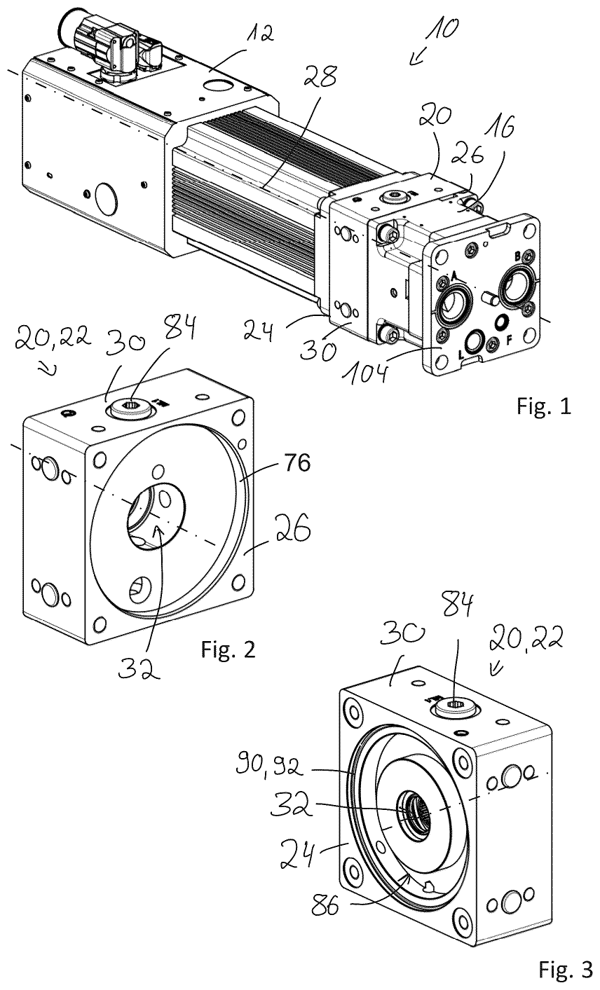

### FIG. 1 is a perspective view of a motor pump unit;

FIG. 2 is a first perspective view of an adapter of the motor pump unit according to FIG. 1;

FIG. 3 is a second perspective view of an adapter of the motor pump unit according to FIG. 1;

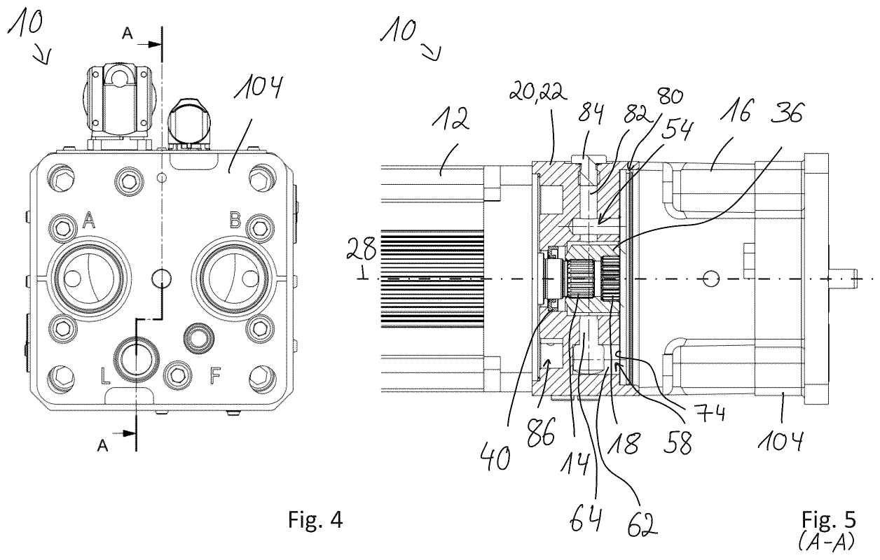

FIG. 4 is a front view of a pump unit of the motor pump unit according to FIG. 1;

FIG. 5 is a longitudinal section of the motor pump unit according to FIG. 1;

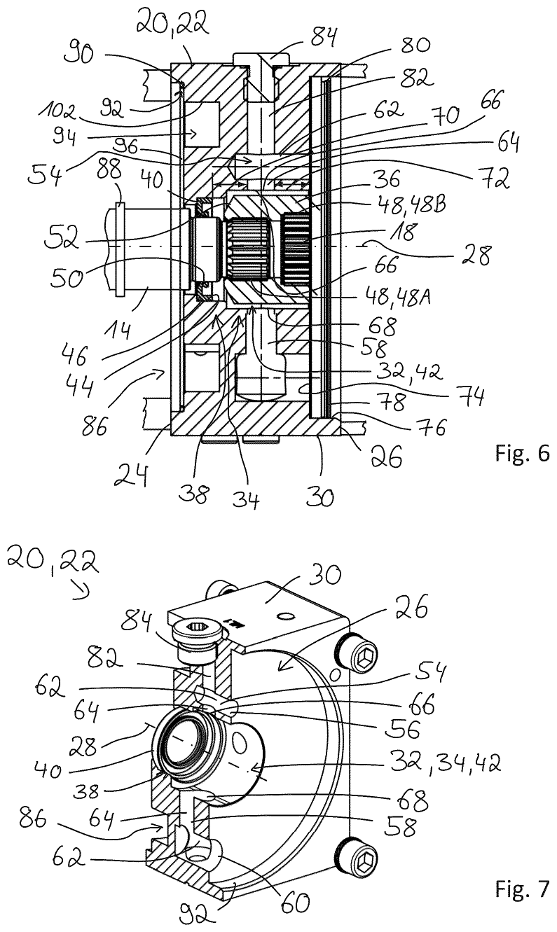

FIG. 6 is a longitudinal section of the adapter according to FIG. 2;

FIG. 7 is a perspective sectional view of the adapter according to FIG. 2;

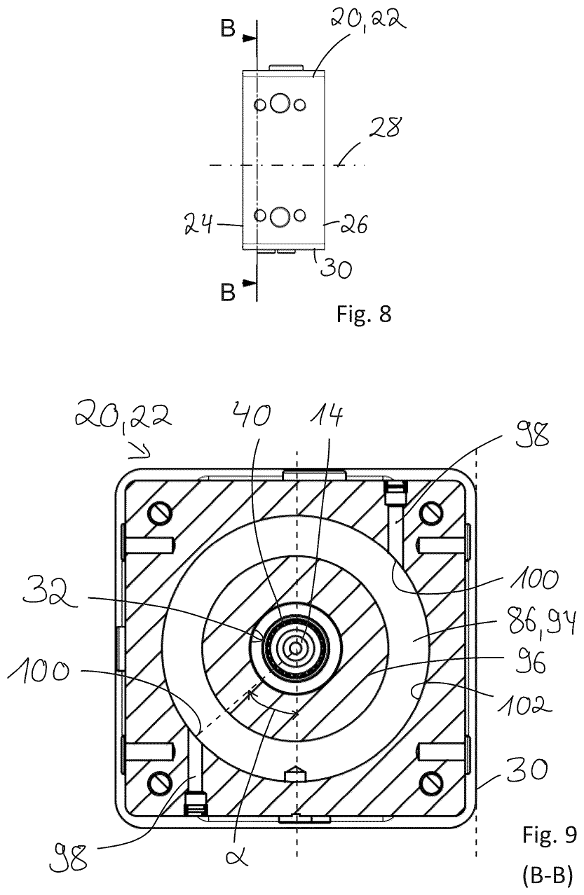

FIG. 8 is a side view of the adapter according to FIG. 2; and

FIG. 9 is a perspective view of the adapter according to FIG. 2.

The motor pump unit 10 for driving a hydraulic cylinder (not shown) has, according to FIG. 1, an electric motor unit 12, a hydraulic pump unit 16, and an adapter 20 for connecting the motor unit 12 and the pump unit 16.

According to FIGS. 2 and 3, the adapter 20 has an adapter housing 22 having a motor-side end face 24 and a pump-side end face 26, wherein the motor-side end face 24 and the pump-side end face 26 each run perpendicular to an axis of rotation 28. The adapter 20 preferably has a rectangular, in particular square, cross-section. Therefore, the motor-side end face 24 and the pump-side end face 26 are connected by four lateral surfaces 30. The lateral surfaces 30 preferably run parallel to the axis of rotation 28.

According to FIGS. 2 and 3, a rotationally symmetrical recess 32 is provided in the adapter 20 and runs along the axis of rotation 28. The recess 32 has a coupling portion 34 for receiving a coupling unit 36, wherein, according to FIGS. 5 and 6, a motor shaft 14 of the motor unit 12 and a pump shaft 18 of the pump unit 16 are coupled by means of the coupling unit 36 for transmitting torque.

According to FIG. 6, the coupling unit 36 is a form-fitting and elastomer-free coupling unit. The coupling unit 36 is hollow-cylindrical and has an internal thread 48 with a first internal thread portion 48A and a second internal thread portion 48B. The free end of the motor shaft 14 and the free end of the pump shaft 18 are arranged within the coupling unit 36. The first internal thread portion 48A meshes in the assembled state with an external thread of the motor shaft 14, and/or the second internal thread portion 48B meshes in the assembled state with an external thread of the pump shaft 18. The diameter of the pump shaft 18 is preferably larger than the diameter of the motor shaft 14.

According to FIGS. 3, 5, 6, and 7, a seal receptacle 38 provided in the recess 32 for receiving a motor shaft seal 40, in particular a radial shaft sealing ring, is connected to the coupling portion 34. The seal receptacle 38 has a radial receiving surface 44 extending parallel to the axis of rotation 28 and an axial receiving surface 46 extending perpendicular to the axis of rotation 28, wherein the motor shaft seal 40 is supported on the radial receiving surface 44, the axial receiving surface 46, and a seal shoulder 50 of the motor shaft 14. The seal receptacle 38 is preferably arranged closer to the motor-side end face 24 than to the pump-side end face 26.

The motor shaft seal 40 fluidically separates the recess 32, wherein, on the pump side, a fluid chamber 42 is formed, into which a pump operating fluid can flow.

According to FIG. 6, the coupling portion 34 has on its lateral surface 30 a bevel 52, facing the seal receptacle 38, which causes a fluid to preferably be guided to the motor shaft seal 40.

According to FIGS. 6 and 7, a first fluid channel 54 with a first fluid connection 56 arranged in the pump-side end face 26 and a second fluid channel 58 with a second fluid connection 60 arranged in the pump-side end face 26 are provided in the adapter housing 22 in addition to the recess 32. By means of the first fluid channel 54, the first fluid connection 56 is fluidly connected to the recess 32. By means of the second fluid channel 58, the second fluid connection 60 is fluidly connected to the recess 32. The first fluid channel 54 and the second fluid channel 58 are fluidically connected by means of the recess 32.

The first fluid channel 54 preferably has a smaller cross-section than the second fluid channel 58. This ensures safe discharge of the pump operating fluid from the adapter 20.

A cavity is provided as part of the fluid chamber 42 between the coupling unit 36, mounted in the recess 32, and the adapter housing 22 so that a fluid can be conducted between the coupling unit 36 from the first fluid channel 54 to the second fluid channel 58 via the cavity.

According to FIGS. 5 to 7, the first fluid channel 54 has a first channel portion 62 extending parallel to the axis of rotation 28 and a second channel portion 64 extending perpendicular to the axis of rotation 28. The first fluid channel 54, in particular the second channel portion 64 of the first fluid channel 54, opens into the recess 32, in particular into the coupling portion 34, at a first recess opening 66.

According to FIGS. 5 to 7, the first channel portion 62 of the first fluid channel 54 and/or the second fluid channel 58 can be configured as a blind hole introduced from the pump-side end face 26. The second channel portion 64 of the first fluid channel 54 and/or the second fluid channel 58 can be configured as a through-hole introduced from opposite lateral surfaces 30 and opening into the recess 32. Alternatively, the second channel portion 64 of the first fluid channel 54 and the second channel portion 64 of the second fluid channel 58 are formed as a common blind hole introduced from a lateral surface 30. The blind hole passes through the recess 32 and opens into the first channel portion 62 of the first fluid channel 54 or the second fluid channel 58.

According to FIGS. 5 to 7, the second fluid channel 58 also has a first channel portion 62 extending parallel to the axis of rotation 28 and a second channel portion 64 extending perpendicular to the axis of rotation 28. The second fluid channel 58, in particular the second channel portion 64 of the first fluid channel 54, opens into the recess 32, in particular into the coupling portion 34, at a second recess opening 68.

In order for a fluid from the first recess opening 66 to also, or at least substantially, flow past the motor shaft seal 40, the first recess opening 66 and/or the second recess opening 68 has/have a first opening distance 70, which runs parallel to the axis of rotation 28, with respect to the motor shaft seal 40 and a second opening distance 72, which runs parallel to the axis of rotation 28, with respect to the pump-side end face 26. According to FIG. 6, the first mouth distance 70 is preferably smaller than the second mouth distance 72. Accordingly, the first recess opening 66 and/or the second recess opening 68 is/are arranged in the region of the motor shaft seal 40 and/or the motor-side end face 24.

In the assembled state, the first fluid connection 56 preferably connects to a fluid outlet (not shown), in particular to a leakage line or flushing line, of the pump unit 16. In the assembled state, the second fluid connection 60 preferably connects to a fluid inlet (not shown), in particular to a leakage line or flushing line, of the pump unit 16. The fluid inlet and/or fluid outlet is/are preferably arranged on a pump end face 74, running perpendicular to the axis of rotation 28, of the pump unit 16. By means of the fluid outlet, a pump operating fluid can be conveyed from the pump unit 16 into the adapter 20. The pump operating fluid flows from the first fluid connection 56 into the recess 32 via the first fluid channel 54. There, the pump operating fluid flows around the motor shaft seal 40 and the coupling unit 36. The coupling unit 36 is therefore lubricated. Particles that have accumulated in the adapter 20 are removed by the pump operating fluid. The pump operating fluid can serve to cool the adapter 20, in particular the coupling unit 36 and/or the motor shaft seal 40. Due to the pressure applied to the fluid outlet of the pump unit 16, the pump operating fluid circulates through the adapter 20. An additional pump is not required. It is advantageous that the existing pump operating fluid is used to flush the coupling unit 36 and the motor shaft seal 40.

Due to the pressurized pump operating fluid, the motor shaft seal 40 is preferably configured for a pressure of more than 3 bar, in particular more than 5 bar, preferably more than 7 bar, and preferably equal to or more than 10 bar. It is also advantageous if the motor shaft seal 40 has a high chemical resistance. A sealing limit of the motor shaft seal 40 preferably ranges between 25 bar*m/s and 40 bar*m/s.

According to FIG. 6, a seal seat 76 is provided on the pump-side end face 26 of the adapter housing 22, wherein an adapter seal 78 is arranged on the seal seat 76 and seals the recess 32 and/or the first fluid connection 56 and/or the second fluid connection 60 toward the radial outside with respect to the axis of rotation 28. The adapter seal 78 is preferably configured as a static seal. This ensures that the pump operating fluid can be safely conveyed between the pump unit 16 and the adapter 20. The seal seat 76 preferably projects axially and can axially receive the pump end face 74. The adapter seal 78 is preferably arranged between the seal seat 76 and a pump housing seal shoulder 80. Alternatively, the recess 32 and/or the first fluid connection 56 and/or the second fluid connection 60 may each be individually sealed by sealing rings.

According to FIGS. 5 to 7, a sensor channel 82 is preferably provided in the adapter housing 22 and opens at one end into the at least one lateral surface 30 and at the other end into the recess 32, and wherein a sensor 84, in particular a pressure sensor and/or a temperature sensor, is arranged in the sensor channel 82. In the sensor channel 82, a threaded connection is provided into which the sensor 84 is screwed. The sensor 84 closes and/or seals the first fluid channel 54 and/or the second fluid channel 58 toward the lateral surface 30 of the adapter housing 22. The motor pump unit 10, in particular the pump unit 16 and/or the adapter 20, can be monitored by means of the sensor 84. The sensor 84 preferably generates data relating to the actual pressure and/or the actual temperature, which can be used to control the motor pump unit using open-loop and closed-loop control. The data can be made available to an integrated or primary control unit.

According to FIGS. 3, 5, 6 and 9, a fluid reservoir 86 for receiving pump operating fluid is arranged on the motor-side end face 24 of the adapter housing 22. The motor shaft seal 40 is arranged between the fluid chamber 42 formed by the motor shaft seal 40 and the fluid reservoir 86. Should pump operating fluid flow past the motor shaft seal 40, it is necessary that this pump operating fluid not flow to the motor of the motor unit 12. Therefore, the motor unit 12 has a further motor shaft seal 88 which is separate from the motor shaft seal 40 and spaced apart therefrom, as shown in FIG. 6, and which is also arranged on the motor shaft 14. The pump operating fluid is held in the fluid reservoir 86, which is delimited by the adapter housing 22, the motor housing, the motor shaft seal 40 and the further motor shaft seal 88, as well as a reservoir seal 90. To receive the reservoir seal 90, a further seal seat 92 is provided on the motor-side end face 24 of the adapter housing 22 for sealing the fluid reservoir 86.

According to FIGS. 6, 7, and 9, the fluid reservoir 86 is formed by a recessed portion introduced in the adapter housing 22 on the motor-side end face 24. The recessed portion has the rotationally symmetrical further seal seat 92. Within the further seal seat 92, a, preferably annular, reservoir pocket 94 and a feed portion 96 for feeding the pump operating fluid from the motor shaft seal 40 into the reservoir pocket 94 are provided. The reservoir pocket 94 is axially recessed relative to the seal seat 76 and/or the feed portion 96. The reservoir pocket 94 is arranged perpendicular to the axis of rotation 28 next to the motor shaft seal 40. Accordingly, the motor shaft seal 40 and the reservoir pocket 94 lie in an imaginary plane running perpendicular to the axis of rotation 28.

According to FIG. 9, two relief holes 98 are preferably provided in the adapter housing 22, which holes run perpendicular to the axis of rotation 28 and/or parallel to a lateral surface 30 and open into the fluid reservoir 86, in particular into the reservoir pocket 94, preferably into an outer side 102 of the reservoir pocket 94, by means of relief connections 100. The relief connections 100 are arranged on the fluid reservoir 86 in such a way that an imaginary line connecting the relief connection 100 and the axis of rotation 28 forms an angle α of 45° with the at least one lateral surface 30. Accordingly, the motor pump unit 10 can be assembled in different positions, in particular 0°, 90°, 180°, and/or 270°, and the pump operating fluid that has accumulated in the fluid reservoir 86 only flows out once a limit quantity is exceeded. The capacity is determined by the position of the relief connections 100. The capacity is configured in such a way that the pump operating fluid received during the running-in phase remains below the limit quantity and is therefore not discharged. This leads to a satisfied customer after start of operation, even if there is an unavoidable leak in the motor shaft seal 40. More pump operating fluid, which is collected in the fluid reservoir 86 during a leakage phase, exceeds the limit quantity, such that some of the pump operating fluid is conducted to the lateral surface 30 of the adapter 20. This provides an indicator of the leakiness of the motor shaft seal 40, especially during the leakage phase.

The fluid reservoir 86 or the recessed portion forms a cavity and/or a spatial distance parallel to the axis of rotation 28 between the adapter 20 and the motor unit 12. Accordingly, heat conduction between the motor unit 12, in particular the A-flange of the motor unit 12, and the adapter 20 is reduced. This results in less heat generated by the motor unit 12 being transferred to the adapter 20 and the pump unit 16. Preferably, a further seal seat 92 is arranged on the motor-side end face 24 for sealing the fluid reservoir 86. The reservoir seal 90 is preferably static. In addition, the pump operating fluid received in the fluid reservoir 86 has a cooling effect. The A-flange of the motor unit 12 has a temperature ranging between 90°and 130°during operation. This leads to evaporation of the pump operating fluid in the fluid reservoir 86. The required evaporation enthalpy causes the motor unit 12, the adapter 20, and thus also the pump unit 16 to cool down. Should there be an increase in pressure in the fluid reservoir 86, gases can escape through the relief hole 98, and the excess pressure can thus be reduced. The running-in phase of the motor shaft seal 40 ensures that pump operating fluid is present in the fluid reservoir 86 at least at the start of operation.

According to FIG. 1, a control block 104 for connection to a hydraulic cylinder, in particular by means of hoses or pipes, is arranged on a further end face of the pump unit 16. The connection points for the hydraulic cylinder are arranged on a control block end face which faces away from the pump unit 16.

### LIST OF REFERENCE SIGNS

10 Motor pump unit
12 Motor unit
14 Motor shaft
16 Pump unit
18 Pump shaft
20 Adapter
22 Adapter housing
24 Motor-side end face
26 Pump-side end face
28 Axis of rotation
30 Lateral surface
32 Recess
34 Coupling portion
36 Coupling unit
38 Seal receptacle
40 Motor shaft seal
42 Fluid chamber
44 Radial receiving surface
46 Axial receiving surface
48 Internal thread
48A First internal thread portion
48B Second internal thread portion
50 Seal shoulder
52 Bevel
54 First fluid channel
56 First fluid connection
58 Second fluid channel
60 Second fluid connection
62 First channel portion
64 Second channel portion
66 First recess opening
68 Second recess opening
70 First opening distance
72 Second opening distance
74 Pump end face
76 Seal seat
78 Adapter seal
80 Pump housing seal shoulder
82 Sensor channel
84 Sensor
86 Fluid reservoir
88 Additional motor shaft seal
90 Reservoir seal
92 Additional seal seat
94 Reservoir pocket
96 Feed portion
98 Relief holes
100 Relief connections
102 Outside of the pocket
104 Control bloc

Although specific features of the present invention are shown in some drawings and not in others, this is for convenience only, as each feature may be combined with any or all of the other features in accordance with the invention. While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

It is the intention, therefore, to be limited only as indicated by the scope of the claims appended hereto. Other embodiments will occur to those skilled in the art after reviewing the present disclosure and are within the following claims.

What is claimed is:

1. An adapter configured to connect an electric motor unit and a hydraulic pump unit, the adapter comprising:
an adapter housing having a motor-side end face and a pump-side end face, wherein the motor-side end face and the pump-side end face each run perpendicular to an axis of rotation,
a recess, running along the axis of rotation and provided in the adapter housing, for receiving a coupling unit, wherein a motor shaft of the motor unit and a pump shaft of the pump unit can be coupled by means of the coupling unit in order to transmit torque,
a seal receptacle provided in the recess in the region of the motor-side end face,
a motor shaft seal, arranged on or in the seal receptacle, which is intended for arrangement on the motor shaft and for sealing the recess in the direction of the motor-side end face,
a first fluid channel having a first fluid connection arranged in the pump-side end face, and
a second fluid channel having a second fluid connection arranged in the pump-side end face,
wherein the first fluid channel and the second fluid channel are formed such that the recess fluidically connects the first fluid channel and the second fluid channel.

2. The adapter according to claim 1, wherein the first fluid channel has a first channel portion extending parallel to the axis of rotation and a second channel portion extending perpendicular to the axis of rotation, wherein the first channel portion opens into the first fluid connection and/or the second channel portion opens into the recess.

3. The adapter according to claim 1, wherein the first fluid channel and/or the second fluid channel is/are configured such that a fluid flowing between the first fluid channel and the second fluid channel flushes the motor shaft seal.

4. The adapter according to claim 1, wherein the recess is arranged between the first fluid channel and the second fluid channel.

5. The adapter according to claim 1, wherein the motor shaft seal is configured for a pressure of more than 3 bar.

6. The adapter according to claim 1, wherein the adapter further comprises a coupling unit, in particular a form-fitting coupling unit, arranged in the recess.

7. The adapter according to claim 1, wherein the adapter housing has at least one lateral surface running parallel to the axis of rotation and connecting the end faces, wherein a sensor channel is provided which opens at one end into the at least one lateral surface and at the other end into the recess, and wherein a pressure sensor and/or a temperature sensor is or can be arranged in the sensor channel.

8. The adapter according to claim 1, wherein at least one relief hole, which runs in particular perpendicular to the axis of rotation, is provided between the motor shaft seal and the motor-side end face for discharging fluid passing through the motor shaft seal.

9. The adapter according to claim 1, wherein a fluid reservoir for receiving fluid passing through the motor shaft seal is provided between the motor shaft seal and the motor-side end face.

10. The adapter according to claim 8, wherein the at least one relief hole opens into the fluid reservoir by means of a relief connection, and wherein the relief connection is arranged on the fluid reservoir in such a way that an imaginary line connecting the relief connection and the axis of rotation forms an angle ranging from 30° to 60°, in particular of 45°, with the at least one lateral surface.

11. The adapter according to claim 1, wherein a seal seat is provided on the pump-side end face, and wherein an adapter seal is or can be arranged on the seal seat and seals the recess and/or the first fluid channel and/or the second fluid channel toward the radial outside with respect to the axis of rotation.

12. The adapter according to claim 1, wherein fastening receptacles for receiving motor-side fastening means are provided on the motor-side end face, wherein the motor-side fastening means are configured to fasten the motor unit to the adapter, and/or wherein fastening receptacles for receiving pump-side fastening means are provided on the pump-side end face, wherein the pump-side fastening means are configured to fasten the pump unit to the adapter.

13. The adapter according to claim 1, wherein a free end of a motor shaft of the motor unit and a free end of a pump shaft of the pump unit are arranged in the recess and are coupled by means of the coupling unit.

14. A motor pump unit comprising:
a motor unit;
a pump unit; and
an adapter which connects the motor unit and the pump unit, the adapter including:
an adapter housing having a motor-side end face and a pump-side end face, wherein the motor-side end face and the pump-side end face each run perpendicular to an axis of rotation,
a recess, running along the axis of rotation and provided in the adapter housing, for receiving a coupling unit, wherein a motor shaft of the motor unit and a pump shaft of the pump unit can be coupled by means of the coupling unit in order to transmit torque,
a seal receptacle provided in the recess in the region of the motor-side end face,
a motor shaft seal, arranged on or in the seal receptacle, which is intended for arrangement on the motor shaft and for sealing the recess in the direction of the motor-side end face,
a first fluid channel having a first fluid connection arranged in the pump-side end face, and
a second fluid channel having a second fluid connection arranged in the pump-side end face,
wherein the first fluid channel and the second fluid channel are formed such that the recess fluidically connects the first fluid channel and the second fluid channel.

15. The motor pump unit according to claim 14, wherein the motor unit has a motor shaft extending along the axis of rotation into the recess, and wherein the motor shaft seal of the adapter is arranged on the motor shaft such that pump operating fluid coming from the pump unit does not reach the motor unit.

16. The motor pump unit according to claim 14, wherein the pump unit has a pump shaft extending along the axis of rotation into the recess, and in particular wherein the pump shaft (18) and the motor shaft are coupled in the recess by means of a coupling unit.

17. The motor pump unit according to claim 14, wherein a fluid outlet corresponding to the first fluid connection and a fluid inlet corresponding to the second fluid connection are provided on a pump end face facing the adapter such that a pump operating fluid can be conveyed from the pump unit to the adapter by means of the fluid outlet and the first fluid connection and from the adapter back to the pump unit by means of the second fluid connection and the fluid inlet.

18. The motor pump unit according to claims 14, wherein an adapter seal is provided between the adapter and the pump unit for sealing the connection between the fluid connections of the adapter and the fluid inlet and the fluid outlet of the pump unit.

19. The motor pump unit according to claim 14, wherein a further motor shaft seal is provided on the motor shaft in the motor unit and is intended for sealing a motor of the motor unit with respect to the fluid reservoir.

20. The motor pump unit according to claim 14, wherein the fluid reservoir is delimited at one end by the motor-side end face and at the other end by the motor unit, in particular the further motor shaft seal.

21. A method for operating a motor pump unit, comprising:
a) selecting a pump unit, a motor unit, and an adapter, wherein the adapter includes:
an adapter housing having a motor-side end face and a pump-side end face, wherein the motor-side end face and the pump-side end face each run perpendicular to an axis of rotation,
a recess, running along the axis of rotation and provided in the adapter housing, for receiving a coupling unit, wherein a motor shaft of the motor unit and a pump shaft of the pump unit can be coupled by means of the coupling unit in order to transmit torque,
a seal receptacle provided in the recess in the region of the motor-side end face,
a motor shaft seal, arranged on or in the seal receptacle, which is intended for arrangement on the motor shaft and for sealing the recess in the direction of the motor-side end face,
a first fluid channel having a first fluid connection arranged in the pump-side end face, and
a second fluid channel having a second fluid connection arranged in the pump-side end face,
wherein the first fluid channel and the second fluid channel are formed such that the recess fluidically connects the first fluid channel and the second fluid channel, and
wherein the adapter is configured to be separate from and connectable to the pump unit and the motor unit;
b) conducting the pump operating fluid from the pump unit into the adapter, and
c) flushing the motor shaft seal and/or a coupling unit, which couples a motor shaft of the motor unit and a pump shaft of the pump unit, by means of the pump operating fluid.

22. The method according to claim 21, further comprising the step of:
d) returning the pump operating fluid, conducted past the motor shaft seal and/or the coupling unit, to the pump unit.
